(19) United States
(12) Patent Application Publication
(10) Pub. No.: US 2026/0037521 A1
(43) Pub. Date: Feb. 5, 2026

(54) QUERY RESOLUTION MANAGEMENT

(71) Applicant: Honeywell International Inc., Charlotte, NC (US)

(72) Inventors: Ankit Singh, Apex, NC (US); Waad Subber, Schenectady, NY (US); Eric Hartye, Oak Ridge, TN (US)

(21) Appl. No.: 18/793,962

(22) Filed: Aug. 5, 2024

(51) Int. Cl. G06F 16/2457; G06F 16/242

(52) U.S. Cl. CPC G06F 16/24575; G06F 16/2425

(57) ABSTRACT

Approaches for generating purpose driven responses to queries are described. According to one example, a query may be processed to determine an application field based on a context of the query and accordingly a set of customized prompts may be generated and then combined before being parsed through a query resolution model along with the query to generate a tailored response. The present invention enables tailored responses by leveraging multiple prompts to provide context and customization before querying the query resolution model.

### BACKGROUND

Organizations across various industries, such as life sciences, pharmaceuticals, medical devices, finance, and technology, accumulate vast amounts of data content as part of various operational, research, and strategic operations associated with the organizations. The data content forms the basis for insightful response generation to any query received from a user, for example, in the form of a report. For example, on receiving a query on analysis of an organization's finances, analytical reports may be generated based on the data content. The insightful responses may also be used for analysis of performance of operations of an organization, for analysis of market trends, new products, preference of consumers, etc. Rapid development of information technologies such as artificial intelligence has enabled various intelligent interaction software and devices for providing intelligent interaction functions for generating responses to such queries received from the user.

### SUMMARY OF INVENTION

This summary is provided to introduce concepts related to generating purpose driven responses to queries received from a user, especially related to various organizations. This summary is not intended to identify essential features of the claimed subject matter nor is it intended for use in determining or limiting the scope of the claimed subject matter.

In an aspect of the present subject matter, a method for generating purpose driven responses to queries using a query resolution model on a final prompt is disclosed. The method includes processing a query to determine an application field of the query based on a context of the query. Further, in the method, a first prompt having a specific set of requirements is generated. In an example, the specific set of requirements defines a customizable format to be used for delivering a response to a user in reply to the query. Further, the method also includes generating a second prompt defining a customizable application specific workflow. The customizable application specific workflow is associated with the application field of the query. Further, a first combined prompt is generated by combining context of the first prompt and context of the second prompt. In addition, as per the method, the first combined prompt and the query are parsed through a query resolution model for generating the response to the query.

In another aspect of the present subject matter, a system for generating purpose driven responses to queries using a query resolution model after every prompt is disclosed. The system includes a query resolution engine to determine an application field of a query using a context of the query received from a user and to further generate a first prompt having a specific set of requirements. The specific set of requirements defines a customizable format to be used for delivering a response to a user in reply to the query. The query resolution engine parses the first prompt and the query through the query resolution model for generating a first response to the query. Thereafter, the query resolution engine generates a second prompt defining a customizable application specific workflow, wherein the customizable application specific workflow is associated with the application field of the query. Yet further, the query resolution engine generates a second prompt defining a customizable application specific workflow. The customizable application specific workflow is associated with the application field of the query. Again, the query resolution engine parses the second prompt, the query, and the first response through the query resolution model for generating a second response to the query. Further, the query resolution engine generates a first combined prompt combining context of the first prompt and context of the second prompt. After that, the query resolution engine parses the first combined prompt, the query, the first response, and the second response through the query resolution model for generating a third response to the query.

In yet another aspect of the present subject matter, a non-transitory computer readable medium for generating purpose driven responses to queries using a query resolution model after every prompt is disclosed. The non-transitory computer readable medium has instructions stored thereon. The instructions, when executed by a processor, cause the processor to perform operations. In the operations, an application field of a query is determined using a context of the query received from a user and accordingly a first prompt having a specific set of requirements is generated. The specific set of requirements defines a customizable format to be used for delivering a response to a user in reply to the query. Further, in the operations, the first prompt and the query are parsed through a query resolution model for generating a first response to the query. Yet further, in the operations, a second prompt is generated defining a customizable application specific workflow. The customizable application specific workflow is associated with the application field of the query. The second prompt, the query, and the first response are parsed through the query resolution model to generate a second response to the query. Further, a first combined prompt is generated by combining context of the first prompt and context of the second prompt and further the first combined prompt, the query, the first response, and the second response are parsed through the query resolution model for generating a third response to the query.

### BRIEF DESCRIPTION OF FIGURES

Systems and/or methods are now described, in accordance with examples of the present subject matter and with reference to the accompanying figures, in which:

FIG. 1 illustrates a system for generating purpose driven responses to queries received from a user, according to an example;

FIG. 2 illustrates a network environment for generating purpose driven responses to queries received from a user, according to another example;

FIG. 3 illustrates a method for generating purpose driven responses to queries, according to an example;

FIG. 4 illustrates a method for generating purpose driven responses to queries, according to another example;

FIG. 5 illustrates a method for generating purpose driven responses to queries, according to another example;

FIG. 6 illustrates a flowchart of parsing of a first combined prompt and a query through a query resolution model, according to an example;

FIG. 7 illustrates a method for generating purpose driven responses to queries, according to another example; and

FIG. 8 illustrates a system environment implementing a non-transitory computer-readable medium for generating purpose driven responses to queries, according to an example.

### DETAILED DESCRIPTION

Various intelligent interaction software and devices are used for providing intelligent interaction functions for generating responses to queries received from any user. Such intelligent interaction software and devices use organization specific data content as the basis for insightful response generation to any query received from the user. report. The insightful responses may be used for analysis of performance of an organization's operations, for analysis of market trends, new products, preference of consumers, etc.

Conventionally, for receiving a response to any query received from a user, a generative artificial intelligence framework, such as large language models may be used by direct integration with the received query. For example, for purpose specific tasks in the pharmaceuticals or medical devices space, such a generative artificial intelligence framework may be used. For responding to the query received from the user, the generative artificial intelligence framework, such as a Large Language Model may be leveraged directly, for example using a token-based approach. In operation, the query is parsed through the generative artificial intelligence framework and accordingly a response is generated by the generative artificial intelligence framework. However, the direct integration with the generative artificial intelligence framework is extremely generic. Thus, such generative artificial intelligence framework can produce logically coherent responses, which may lack the specific context and purpose required for professional or domain-specific applications. Therefore, the generated response, despite being meaningful and logically corelated to the query, is unreliable and does not take into consideration the context for a specific purpose, such as consider regulatory requirements, organizational standards, or application-specific workflows to which the query is directed.

Additionally, existing generative artificial intelligence frameworks may struggle to maintain consistency across different types of applications and users. Further, the existing generative artificial intelligence frameworks often lack the ability to incorporate multiple layers of context, from general formatting requirements to application-specific workflows to individual user needs. This can result in responses that, while factually accurate, may not fully address the nuanced requirements of complex organizational queries.

Approaches for generating purpose driven responses to queries received from a user are described. The present subject matter facilitates a professional consistency in responding to users of all application types by relying on right set of prompts from the perspective of a service provider and the user, i.e., customer that allows to specify more specific context to be taken into consideration before sending the query for parsing to a query resolution model. The present subject matter can generate purpose driven responses that combine the power of artificial intelligence-based models with customizable prompts and workflows tailored to specific organizational and user requirements.

According to an implementation of the present subject matter, a query is received from a user. In an example, the query may be related to a specific application field. The received query is processed for determining an application field of the query. The determination may be made based on the context of the query. For example, if the context of the query is indicating about a process owner recall investigation, the application field of the query may be from Recall application perspective. Now, instead of parsing the query directly through a query resolution model, such as a generative artificial intelligence framework which would have done conventionally, a set of prompts may be generated and then the generated prompts along with the query may be parsed through the query resolution model for obtaining a tailored response. In an example, the query resolution model used for parsing the prompts and the query may be an open artificial intelligence-based model. The query resolution model may leverage advanced machine learning techniques and algorithms to process a high-dimensional vector and generate a response that is semantically and syntactically aligned with contexts of the prompts and the query. The use of an open artificial intelligence-based model, such as a Large Language Model, allows for a high degree of flexibility and adaptability in the response generation process, enabling the system to generate purpose-driven responses to a wide range of queries across various application fields.

For this, a first prompt is generated. The first prompt includes a specific set of requirements that defines a customizable format to be used for delivering a response to a user in reply to the query. The first prompt may set a template for the response when delivered. For example, a specific length of the response, a specific purpose, specific regulatory requirements, disclaimers, or a general tone in which a response is to be delivered to a user.

After generating the first prompt, a second prompt may be generated. The second prompt defines a customizable application specific workflow associated with the application field of the query. For example, for the application related to a recall perspective, the application specific workflow may be customized to include submodules such as Global partition signal detection, Quality Investigation, Process owner recall investigation, Recall Execution, Recall Disposition, and Recall communication. Further, the context of the first prompt and context of the second prompt are combined to generate a first combined prompt. The combination of the prompts is done to ensure that the context of the first prompt and context of the second prompt are not sent separately but as a combined prompt for specifying a clearer purpose and to ensure that any customized aspect is not missed out. Yet further, the first combined prompt and the query are parsed through the query resolution model, i.e., a large language model for generating the response to the query.

In an example, for obtaining a more tailored response, a third prompt may be generated. The third prompt indicates a user specific requirement having an additional context specifying the user specific requirement. For example, the user may provide a specific text box where the purpose of a specific query may be specified. The additional context may state the intention that could be extremely specific to the purpose of a task to which the query relates to. After generating the third prompt, a second combined prompt may be generated by combining context of the first combined prompt and context of the third prompt before getting the second combined prompt and the query parsed through the query resolution model for generating the response to the received query. The generated response is more tailored as per the specific requirement of the user.

Further, additional layers may be added by generating one or more intermediate prompts after the generation of the second prompt in case additional context needs to be specified for the application specific workflow. The additional context may not be specified in sub-modules of the application specific workflow.

According to an example implementation of the present subject matter, instead of parsing all the prompts, i.e., combined prompt generated based on combining previously generated prompts, once through the query resolution model for generating a response to the query, the prompt generated at each step of response generation may be parsed through the query resolution model to first get a very large generic response and then use that response to get new context from the user and send back to the query resolution model.

The present invention thus ensures a professional consistency in responding to users of all application types as the response follows a specific set of requirements. The present invention relies on the right set of prompts from the perspective of service provider and the user, i.e., customer that allow to specify more specific context to be taken into consideration before sending the query for parsing to the query resolution model. In addition, the present invention enables versatile levels of customization where the user may choose any number of layers or prompts before sending the query to the query resolution model to get a more tailored response.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

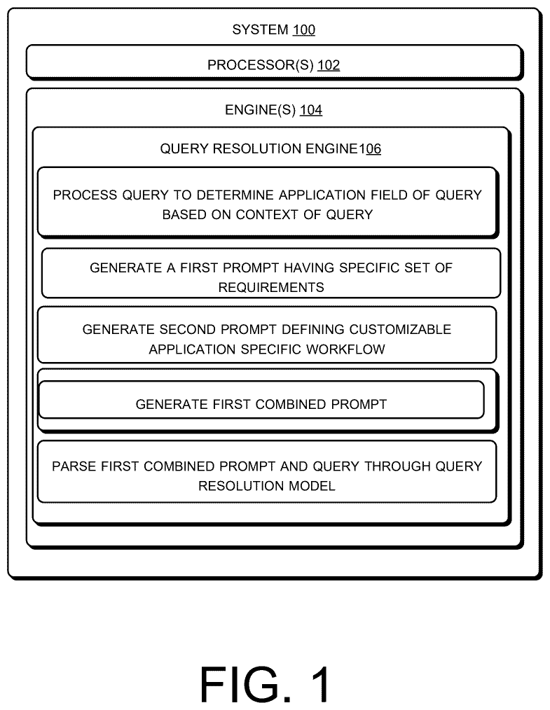

FIG. 1 illustrates a system 100 for generating purpose driven responses to queries received from a user, according to an example. The query may be related to a specific application field and the desired response may be related to the same specific application field to which the query relates to. The user may be a customer related to the same specific application field. The queries and the response may relate to information pertaining to an organization, such as sales data, customer data, development data, and so on. In organizations, the data content may be generally presented in the form of analytical reports that may have analytical data associated with an organization and the analytical data may be a basis for generating the responses.

The system 100 may be a device, such as an electronic device, that may be operated by the user for generating purpose driven responses to the query(s). Examples of the electronic device may include, but are not limited to, a laptop, a desktop, a tablet computer, and a smart phone. The system 100 may be implemented in any computing system, such as a storage array, server, desktop or a laptop computing device, a distributed computing system, or the like. Although not depicted, the system 100 may include other components, such as interfaces to communicate over the network or with external storage or computing devices, display, input/output interfaces, operating systems, applications, data, and other software or hardware components (all of which have not been depicted).

In one example, the system 100 may be a standalone server or may be a remote server on a cloud computing platform. In a preferred example, the system 100 may be a cloud-based system. The system 100 is capable of delivering applications (such as cloud applications) for creating and executing queries on the data content. The cloud-based system allows for a scalable and flexible deployment of the system 100, enabling it to handle a large volume of queries and generate responses in a timely manner. The cloud-based implementation of the system 100 may also facilitate easy access to the system 100 by users from various locations and devices, thereby enhancing the usability and accessibility of the system 100.

The system 100 may include a processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 104 may be implemented as electronic circuitry. The engine(s) 104 includes a query resolution engine 106.

In operation, the query resolution engine 106 of the system 100 receives a query from a user. In an example, the query may be related to a specific application field and includes a context associated to the specific application field. For example, if the query is for a quality management solution for the pharma industry, the context of the query will be an indicative of quality management solution that may direct the query to relevant resources. In an example, the user may be a team lead in a department ‘A’ of an organization and the user has a query related to a department ‘B’ of the same organization. In such a case, the system 100 may help in resolving such cross department queries.

The query resolution engine 106 further determines an application field of the query by processing the received query. Such a determination may be made based on the context of the query. In an example, in the processing the received query, the query resolution engine 106 may parse the context of the query to ascertain the application field of the query. For example, if the context of the query is indicating about a process owner recall investigation, the application field of the query may be from Recall application perspective. Processing of query from any application field is possible by the query resolution engine 106 and accordingly a tailored response may be generated by the query resolution engine 106. Conventionally, the context of the query would have parsed directly through a query resolution model to generate a convoluted response. On the other hand, the query resolution engine 106 of the present subject matter generates a set of prompts and then the generated prompts along with the query may be parsed through the query resolution model for obtaining a tailored response. In an example, the query resolution model used for parsing the prompts and the query may be an open artificial intelligence-based model. The query resolution model may leverage advanced machine learning techniques and algorithms to process a high-dimensional vector and generate a response that is semantically and syntactically aligned with contexts of the prompts and the query. The use of an open artificial intelligence-based model, such as a Large Language Model, allows for a high degree of flexibility and adaptability in the response generation process, enabling the system to generate purpose-driven responses to a wide range of queries across various application fields.

For this, in further operations, the query resolution engine 106 generates a first prompt. In an example, any number of prompts may be generated by the query resolution engine 106 depending on granularity requirement of the response anticipated by the user. The first prompt may include a set of fixed instructions created by the query resolution engine 106 to constrain the response to be received via the query resolution model, such as a Large Language Model.

The first prompt may include a specific set of requirements that defines a customizable format to be used for delivering a response to a user in reply to the query. The first prompt may set a template for the response when delivered. For example, a specific length of the response, a specific purpose, specific regulatory requirements, disclaimers, or a general tone in which a response is to be delivered to a user. In an example, the query resolution engine 106 may create either one context or different contexts per application. An example template generated by the query resolution engine 106 may be “Please provide response in about 1000 words using concise and citation-specific manner. If you cannot answer, please state ‘Sorry I could not find this information in my Knowledge Base.’. However, if you find the answer, please give 3 most probable citations and always begin the answer with ‘Honeywell Knowledge Base suggests . . . ’. and the last sentence should always say ‘Please verify the sources used in reference.” Such a customizable format ensures a professional consistency in responding to the users of all applications and all types.

Once the first prompt is generated, i.e., the template for the response to be delivered is set, the query resolution engine 106 generates a second prompt. The second prompt defines a customizable application specific workflow associated with the application field of the query. For example, for the application related to a recall perspective, the application specific workflow may be customized to include submodules such as Global partition signal detection, Quality Investigation, Process owner recall investigation, Recall Execution, Recall Disposition, and Recall communication. The second prompt is customizable depending on the application specific workflow and may vary from one application to another. In an example, the second prompt is a set of fixed instructions created by the query resolution engine 106 to constrain the response to be generated by the query resolution model.

Since the second prompt is from the perspective of the application and its various submodules, it is pertaining to the flows within the application. For example, the context at the second prompt may be for example from a Recall application perspective, then the workflows may be like Global partition signal detection->Quality Investigation->Process owner recall investigation->Recall Execution->Recall Disposition->Recall communication. The second prompt may be associated with one or more layers depending on the application type. In such a case, each layer could have a detailed set of contexts defined at the layer where there could be purpose specific prompts. Another example could be for Quality Investigation prompt “Please return the response with the statement that the Quality investigation done across all phases of the financial impact data, risk assessment data and quality material logistics suggest . . . . If you are not sure, please return the statement, kindly read the quality investigation done by process owners PO1, PO2, PO3 etc. to generate the Executive Quality Summary investigation”. Above are just examples and the second prompt may be based on any application type. The second prompt ensures consistency in the way a response is generated for a customer along with the general tone and reference.

The first prompt has set the template of the response to be delivered and the second prompt has customized application specific workflow. Now, the query resolution engine 106 generates a first combined prompt. For generating the first combined prompt, the query resolution engine 106 combines the context of the first prompt and context of the second prompt. The combination of the prompts is done to ensure that the context of the first prompt and context of the second prompt are not sent separately but as a combined prompt for specifying a clearer purpose and to ensure that any customized aspect is not missed out.

Yet further, the query resolution engine 106 parses the first combined prompt and the query through the query resolution model for generating the response to the query. After the parsing, the query resolution engine 106 may obtain only relevant data associated with the first combined prompt and the query for generating a precise response to the query. For example, the query resolution engine 106, for parsing the first combined prompt and the query through the query resolution model, may initially transforms context of the first combined prompt and the context of the query to a high-dimensional vector representing semantic and syntactic characteristics of the contexts. The transformation may involve various techniques such as tokenization, embedding, and vectorization, which convert the textual data of the contexts into a numerical form that can be processed by the query resolution model.

Further, the query resolution engine 106 parses the high-dimensional vector through a vector space of the query resolution model for searching vector embeddings in the vector space close to the high-dimensional vector. The vector space close to the high-dimensional vector is an indicative of location of the precise response to the query. In an example, the query resolution model is an open artificial intelligence based model. In an example, the query resolution model may be a Large Language Model. In an example, the query resolution model may be restricted to a Large Language Model and any open artificial intelligence based model may be used.

The system 100 manages and resolves the queries in a purpose-driven manner by leveraging the query resolution model that combines the power of artificial intelligence with customizable prompts to generate responses that are tailored to specific application fields and user requirements. The system 100 provides a unique approach to query resolution.

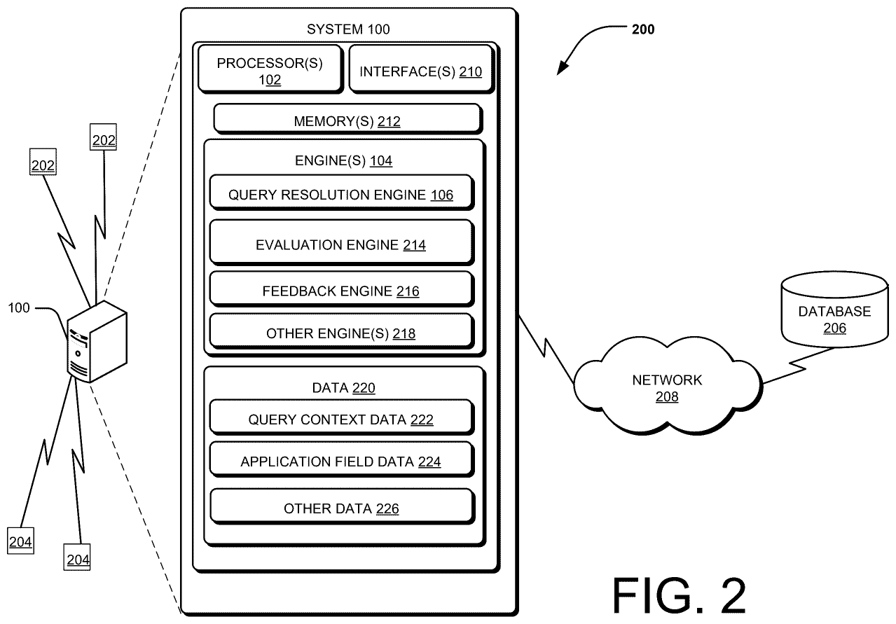

FIG. 2 illustrates a network environment 200 for generating purpose driven responses to queries received from a user 202, 204, according to an example. The user 202 may be a user with an organization.

The user 204 may be a user with outside the organization. The network environment 200 includes the system 100 for generating purpose driven responses to queries received from a user. The system 100 is described in FIG. 1 and may include, but is not limited to, a laptop, a notebook computer, a server computer, a tablet computer. The system 100 may include the processor(s) 102 similar to depicted in FIG. 1. Further, in an example, the system 100 may be connected to a database 206 through a network 208. The database 206 may be, for example, a structured query language (SQL) data store or a not only SQL (NoSQL) data store. In an exemplary implementation, the database 206 may be configured as cloud-based database implemented in the software as a service environment. In another exemplary implementation, the database 206 may be a location on a file system directly accessible by the engines. The database 206 may be configured to store data of the queries and data of different prompts and the like. The cloud-based implementation may also enable easy integration of the system 100 with other cloud-based services or systems, thereby expanding the capabilities and functionalities of the system 100. For example, the system 100 may be integrated with a cloud-based data analytics service to analyze the queries and responses, or with a cloud-based machine learning service to train and improve the query resolution model.

The network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example,

Hypertext Transfer Protocol (HTTP), Transmission Control Protocol/Internet Protocol (TCP/IP), Wireless Application Protocol (WAP), etc., to communicate with each other.

In one implementation, the network environment 200 may be an artificial intelligence based network, including personal computers, laptops, various servers, such as blade servers, and other computing devices connected over the network 208. The system 100 includes the processor(s) 102. Further, the system 100 includes interface(s) 210 and memory(s) 212. The interface(s) 210 may allow the connection or coupling of the system 100 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 100.

The engine(s) 104 of the system 100 may further include an evaluation engine 214, a feedback engine 216, and other engines 218 in addition to the query resolution engine 106 as depicted in FIG. 1. The feedback engine 216, the evaluation engine 214, and the other engines 218 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry. The system 100 may further include data 220. The data 220 may further include query context data 222, application field data 224, and other data 226.

The network environment 200 is in operation once the query resolution engine 106 receives a query from the user for generating a response to that query. In an example, the user may be a customer or a client. Post receiving the query, in one implementation, firstly a final prompt or a combined prompt is generated based on a specified set of requirements and then the final prompt or the combined prompt and the query are parsed through a query resolution model, for example, a Large Language Model, for generating the response to the query.

For executing this, in an example, the query resolution engine 106, after receiving the query determines an application field of the query by processing the received query. This determination is crucial because the query may be related to a specific application field and may be made based on the context of the query associated to the specific application field. For example, if the query is for a quality management solution for the pharma industry, the context of the query will be an indicative of quality management solution that may direct the query to relevant databases. During the processing of the query, the query resolution engine 106 may parse the context of the query to ascertain the application field of the query. Processing of query from any application field is possible by the query resolution engine 106 and accordingly a tailored response may be generated by the query resolution engine 106.

In further operation, the query resolution engine 106 may generate a first prompt. In an example, any number of prompts may be generated by the query resolution engine 106 depending on granularity requirement of the response anticipated by the user. The first prompt may include a set of fixed instructions created by the query resolution engine 106 to constrain the response to be received via the query resolution model, such as a Large Language Model. The first prompt may include a specific set of requirements that defines a customizable format to be used for delivering a response to a user in reply to the query. The first prompt may set a template for the response when delivered. For example, a specific length of the response, a specific purpose, specific regulatory requirements, disclaimers, or a general tone in which a response is to be delivered to a user. The customizable format ensures a professional consistency in responding to the users of all applications and all types.

The first prompt sets the template for the response to be delivered and then the query resolution engine 106 may generate a second prompt defining a customizable application specific workflow associated with the application field of the query. For example, for the application related to a recall perspective, the application specific workflow may be customized to include submodules such as Global partition signal detection, Quality Investigation, Process owner recall investigation, Recall Execution, Recall Disposition, and Recall communication. In an example, the second prompt is a set of fixed instructions created by the query resolution engine 106 to constrain the response to be generated by the query resolution model.

Since the second prompt is from the perspective of the application and its various submodules, it is pertaining to the flows within the application. The second prompt may be associated with one or more layers depending on the application type. In such a case, each layer could have a detailed set of contexts defined at the layer where there could be purpose specific prompts. The second prompt ensures additional consistency in the way a response is generated for a customer along with the general tone and reference.

Now, the query resolution engine 106 may either generate a first combined prompt combining the context of the first prompt and context of the second prompt or further generate a third prompt.

In case the query resolution engine 106 generates the first combined prompt, which is done to ensure that the context of the first prompt and context of the second prompt are not sent separately but as a combined prompt for specifying a clearer purpose and to ensure that any customized aspect is not missed out, the first combined prompt and the query may be parsed through the query resolution model for generating the response to the query. After the parsing, the query resolution engine 106 may obtain only relevant data associated with the first combined prompt and the query for generating a precise response to the query. For example, for parsing the first combined prompt and the query through the query resolution model, the query resolution engine 106 may initially transform context of the first combined prompt and the context of the query to a high-dimensional vector representing semantic and syntactic characteristics of the contexts. Further, the query resolution engine 106 parses the high-dimensional vector through a vector space of the query resolution model for searching vector embeddings in the vector space close to the high-dimensional vector. The vector space close to the high-dimensional vector is an indicative of location of the precise response to the query. In an example, the query resolution model is an open artificial intelligence based model. The transformation may involve various techniques such as tokenization, embedding, and vectorization, which convert the textual data of the contexts into a numerical form that can be processed by the query resolution model.

Otherwise, the query resolution engine 106 may generate the third prompt. The third prompt may indicate a user specific requirement having an additional context specifying the user specific requirement. The additional context defining the third prompt may be from the perspective of a specific user role, where the privilege of the user is considered to generate a meaningful prompt. For example, a user “Nick” may provide a specific text box where he can specify the purpose of a specific query. For example, in addition to the first and second prompts, the third prompt has the prompts from a specific user, like Nick and this user can state the intention that could be extremely specific to the purpose of the task. For example, while it is required to ensure the consistency of response generated between Product Quality Review, such as Honeywell Product Quality Review (HPQR) of Product 1 vs Product 2, but even for an HPQR report for Product 1, based on the specific context, the response may differ. For example, in 2023, Tylenol HPQR report was meant to only focus on quality, manufacturing process and compliance aspects, but in 2024 the report in addition to contexts, must cover the details pertaining to an ongoing recall and the user may be able to enter an additional level of context where they can specify “Please inform the executive about the current recalls with focus on recall effectiveness and recall phased investigation results”. In this way, the query resolution model will honor the contexts from previous stages and take into consideration an additional layer, i.e., the third prompt, being specified.

Now, the query resolution engine 106 may either generate a second combined prompt combining context of the first combined prompt and context of the third prompt or further generate one or more intermediate prompts. The one or more intermediate prompts may be generated either after generating the second prompt or after generating the third prompt depending on the application requirements.

For the second combined prompt being generated by the query resolution engine 106 by combining context of the first combined prompt and context of the third prompt, the query resolution engine 106 may parse the second combined prompt and the query through the query resolution model for generating the response to the received query. Also, the combining of the contexts of the first combined prompt and the third prompt is done to ensure that the context of the first combined prompt and the context of the third prompt are not sent separately but as a combined prompt for specifying a clearer purpose and to ensure that any customized aspect is not missed out. After the parsing, the query resolution engine 106 may obtain only relevant data associated with the second combined prompt and the query for generating a precise response to the query. For example, for parsing the second combined prompt and the query through the query resolution model, the query resolution engine 106 may initially transform context of the second combined prompt and the context of the query to a high-dimensional vector representing semantic and syntactic characteristics of the contexts. Further, the query resolution engine 106 parses the high-dimensional vector through a vector space of the query resolution model for searching vector embeddings in the vector space close to the high-dimensional vector. The vector space close to the high-dimensional vector is an indicative of location of the precise response to the query. This parsing process may involve various machine learning algorithms and techniques, such as nearest neighbor search, cosine similarity, or other distance metrics, to identify vector embeddings in the vector space that are semantically and syntactically similar to the high-dimensional vector.

In an example, the query resolution engine 106 may not go for the second combined prompt and instead generates the one or more intermediate prompts after the generation of the second prompt. The one or more intermediate prompts are to specify additional context for the application specific workflow. In an example, the additional context may relate to a context not specified in sub-modules of the application specific workflow. The one or more intermediate prompts are to ensure that there is no limitation on the number of layers or prompts and users may choose more layers of nesting and construction of prompts before sending to the query resolution model to get a more tailored response. In an example, each of the first prompt, the second prompt, the third prompt, and the one or more intermediate prompts corresponds to a layer of the query resolution model.

Further, the query resolution engine 106 may generate a third combined prompt by combining context of the first combined prompt and context of the one or more intermediate prompts. In an example, if the one or more intermediate prompts are generated after the third prompt, the query resolution engine 106 may generate a third combined prompt by combining context of the second combined prompt and context of the one or more intermediate prompts.

The query resolution engine 106 may further parse the third combined prompt and the query through the query resolution model for generating the response to the received query. Also, the combining of the contexts is done to ensure that the context of the first combined prompt or the second combined prompt and the context of the third prompt are not sent separately but as a combined prompt for specifying a clearer purpose and to ensure that any customized aspect is not missed out. Post the parsing, the query resolution engine 106 may obtain only relevant data associated with the third combined prompt and the query for generating a precise response to the query. For example, for parsing the third combined prompt and the query through the query resolution model, the query resolution engine 106 may initially transform context of the third combined prompt and the context of the query to a high-dimensional vector representing semantic and syntactic characteristics of the contexts. Further, the query resolution engine 106 parses the high-dimensional vector through a vector space of the query resolution model for searching vector embeddings in the vector space close to the high-dimensional vector. The vector space close to the high-dimensional vector is an indicative of location of the precise response to the query.

In each case, the response may be one of an answer to the query, a newly generated text, a summarized text, and an analysis report. In an example, any number of prompts may be generated by the query resolution engine 106 depending on granularity requirement of the response anticipated by the user.

In another implementation, post receiving the query, a prompt is generated based on a specified set of requirements at each step and the generated prompt is parsed after each step along with the query through the query resolution model, for example, a Large Language Model, for generating the response to the query. Parsing the prompt at each step obtains a large generic response, at each step, and then use that response to get new context from the user and send back to the query resolution model.

For executing this, in an example, the query resolution engine 106, after receiving the query determines an application field of the query by processing the received query. This determination may be related to a specific application field and may be made based on the context of the query associated to the specific application field. During the processing of the query, the query resolution engine 106 may parse the context of the query to ascertain the application field of the query.

In further operation, the query resolution engine 106 may generate a first prompt. The first prompt may include a set of fixed instructions created by the query resolution engine 106 to constrain the response to be received via the query resolution model, such as a Large Language Model. The first prompt may include a specific set of requirements defining a customizable format to be used for delivering a response to a user in reply to the query. The first prompt may be a template setting prompt that shows how the response will be visible to the user when it is delivered. For example, a specific length of the response, a specific purpose, specific regulatory requirements, disclaimers, or a general tone in which a response is to be delivered to a user. Now, before generating the next prompt, the query resolution engine 106 may parse the first prompt and the query through the query resolution model for generating a first response to the query. The first response may be a very large generic response that may be used subsequently for a refined response generation.

Post setting the template for the response to be delivered and generating the first generic response, the query resolution engine 106 may generate a second prompt defining a customizable application specific workflow associated with the application field of the query. Since the second prompt is from the perspective of the application and its various submodules, it is pertaining to the flows within the application. The second layer could have a detailed set of contexts defined at the layer where there could be purpose specific prompts. The second prompt ensures additional consistency in the way a response is generated for a customer along with the general tone and reference.

Now, the query resolution engine 106 may either generate a first combined prompt combining the context of the first prompt and context of the second prompt or parse the second prompt, the query, and the first response through the query resolution model for generating a second response to the query, prior to the first combined prompt generation. The second response may be a large generic response that may be used subsequently for a refined response generation. In an example, the second response may be less generic than the first response.

In case the query resolution engine 106 generates the first combined prompt without parsing the second prompt, the query, and the first response through the query resolution model, then the query resolution engine 106 may parse the first combined prompt, the query, and the first response, through the query resolution model for generating a response to the query. Otherwise, when the query resolution engine 106 generates the first combined prompt after generating the second response, the query resolution engine 106 may parse the first combined prompt, the query, the first response, and the second response through the query resolution model for generating a third response to the query. In an example, the third response may be a final response. In an example, if more prompts are to be generated, the third response may be a generic response that may be used subsequently for a refined response generation. In an example, the third response may be less generic than the second response. In each case, the combined prompt ensures that the contexts of the prompts forming the combined prompt are not sent separately but as a combined prompt for specifying a clearer purpose and to ensure that any customized aspect is not missed out. The query resolution engine 106, after every parsing step, may obtain only relevant data associated with one or more of the prompts, the query, and the response for generating a precise response to the query. For example, for the parsing, the query resolution engine 106 may initially transform the context of the prompts, the context of the query, and the context of the generated responses to a high-dimensional vector representing semantic and syntactic characteristics of the contexts. Further, the query resolution engine 106 parses the high-dimensional vector through a vector space of the query resolution model for searching vector embeddings in the vector space close to the high-dimensional vector. The vector space close to the high-dimensional vector is an indicative of location of the precise response to the query. In some cases, the high-dimensional vector is parsed through a vector space of the query resolution model to search for vector embeddings in the vector space that are close to the high-dimensional vector. This parsing process may involve various machine learning algorithms and techniques, such as nearest neighbor search, cosine similarity, or other distance metrics, to identify vector embeddings in the vector space that are semantically and syntactically similar to the high-dimensional vector.

In an example, after generating the third response, the query resolution engine 106 may generate a third prompt. The third prompt may indicate a user specific requirement having an additional context specifying the user specific requirement and is from the perspective of a specific user role. In the third prompt, the privilege of the user is considered to generate a meaningful prompt. For example, a user “Ankit” may provide a specific text area to specify a very particular purpose of a specific query. In an example, Ankit can state extremely specific pointers defining the purpose of the task.

In an example, the query resolution engine 106 may parse the first combined prompt, the query, the first response, the second response, and the third prompt through the query resolution model for generating a response to the query. Otherwise, the query resolution engine 106 may generate a second combined prompt by combining context of the first combined prompt and context of the third prompt. Post generating the second combined prompt, the query resolution engine 106 may parse the second combined prompt, the query, the first response, the second response, and the third response through the query resolution model for generating a final response to the query.

In yet another example, instead of generating the third prompt, the query resolution engine 106 may generate one or more intermediate prompts after the generation of the second prompt. The one or more intermediate prompts may be based on the application requirements. The one or more intermediate prompts are to specify additional context for the application specific workflow. In an example, the additional context may relate to a context not specified in sub-modules of the application specific workflow. The one or more intermediate prompts are to ensure that there is no limitation on the number of layers or prompts and users may choose more layers of nesting and construction of prompts before sending to the query resolution model to get a more tailored response. In an example, each of the first prompt, the second prompt, the third prompt, and the one or more intermediate prompts corresponds to a layer of the query resolution model.

Further, the query resolution engine 106 may generate a third combined prompt by combining context of the first combined prompt and context of the one or more intermediate prompts so that the context of the first combined prompt or the second combined prompt and the context of the third prompt are not sent separately but as a combined prompt for specifying a clearer purpose and to ensure that any customized aspect is not missed out. The query resolution engine 106 may further parse the third combined prompt, the query, the first response, the second response, and the third response through the query resolution model for generating a final response to the query. Thereafter, the query resolution engine 106 may obtain only relevant data associated with the third combined prompt, the query, the first response, the second response, and the third response for generating a precise response to the query. For example, the third combined prompt, the query, the first response, the second response, and the third response may be transformed to a high-dimensional vector and then the high-dimensional vector is parsed through a vector space of the query resolution model for searching vector embeddings in the vector space close to the high-dimensional vector. The vector space close to the high-dimensional vector is an indicative of location of the precise final response to the query. In an example, the query resolution model is a Large Language Model. In an example, in each case, the response, such as first response, second response, third response, final response or any other response generated by the query resolution model may be one of an answer to the query, a newly generated text, a summarized text, and an analysis report.

In an example, the query resolution engine 106 may transform contexts of the first prompt, the second prompt, the third prompt, the first combined prompt, the second combined prompt, the query, the first response, the second response, and the third response to a high-dimensional vector representing semantic and syntactic characteristics of the contexts. Further, the query resolution engine 106 may parse the high-dimensional vector through a vector space of the query resolution model for searching vector embeddings in the vector space close to the high-dimensional vector. Such a parsing helps in generating the precise response to the query. This is an example of generating the response using high-dimensional vector, any other technique capable of generating response to the query based on the prompts may also be used.

Further, the evaluation engine 214 of the system 100 may evaluate the generated responses by measuring one or more of coherence, relevance to context of the query, grammatical correctness, and factual accuracy against a prespecified standard. The generated response may be any response generated during the operation of the system 100. In an example, the generated response may be a first response, a second response, a third response, a final response or any other response generated during the operation of the system 100. The response is one of an answer to the query, a newly generated text, a summarized text, and an analysis report. In an example, any known algorithm may be used to measure coherence, relevance to context of the query, grammatical correctness, and factual accuracy against a prespecified standard of the responses. If the response is evaluated as free of errors, the evaluation engine 214 may communicate the same to the query resolution engine 106, which may further display the evaluated response to the user. If the response is evaluated as erroneous, the evaluation engine 214 may communicate the errors to the query resolution engine 106, which may further rectify the errors before displaying the response to the user. In an example, after correcting the errors, the query resolution engine 106 may again send back the corrected response to the evaluation engine 214 for re-evaluation. This evaluation may involve various natural language processing techniques and metrics, such as BLEU score, ROUGE score, or other evaluation metrics, to assess the quality and relevance of the generated response.

In an example, the feedback engine 216 of the system 100 may receive a user feedback on the third response. In an example, the user feedback is based one or more of coherence, relevance to context of the query, grammatical correctness, and factual accuracy against a prespecified standard.

The approach of the network environment 200 allows a high degree of customization in the response generation process for ensuring that the responses are not only relevant and accurate, but also adhere to specific formats or regulatory requirements as needed. Further, the network environment 200 offers the flexibility to add additional layers or prompts to further refine the response, thereby providing a versatile and adaptable solution for query resolution across various industries and application fields.

In another example, a communication environment (not shown) may implement the system 100 for generating purpose driven responses to queries received from a user, according to another example. In one example, the communication environment may include the system 100 and a response generating application server (not shown). In an example, the response generating application server may store and maintain data associated with the analytical report and give authorized users or the system 100 access to the data. In one example, the response generating application server may be hosted virtually, for example, on a cloud-based platform at a site or away from the site. In another example, the response generating application server may be a stand-alone physical system geographically located either on the site or away from the site. Examples of the site may include, but are not limited to, a building of a company, or any other working environments in any industry or enterprise. The building may be a commercial establishment, for example, a commercial complex, an industrial establishment, a data center, and a storage facility. Further, a building may also refer to a combination of two or more structures or compounds. In an example, the system 100 and the response generating application server may be managed and owned by different entities and may be located at different geographical locations. In another example, the system 100 and the response generating application server may be managed and owned by same entities and may be co-located at a same geographical location. The system 100 and the response generating application server may be communicably coupled with each other over the network 208.

In one example, the response generating application server may include server engine(s) and server data. The response generating application server may include components, other than the depicted components, such as display, processor(s), input/output interfaces, operating systems, applications, and other software or hardware components (not shown in the figures). The server engine(s) may be implemented as a combination of hardware and programming, for example, programmable instructions to implement a variety of functionalities of the server engine(s). In examples described herein, such combinations of hardware and programming may be implemented in several different ways. For example, the programming for the server engine(s) may be executable instructions. Such instructions may be stored on a non-transitory machine-readable storage medium which may be coupled either directly with the response generating application server or indirectly (for example, through networked means). In an example, the server engine(s) may include a processing resource, for example, either a single processor or a combination of multiple processors, to execute such instructions. In the present examples, the non-transitory machine-readable storage medium may store instructions that, when executed by the processing resource, implement server engine(s). In other examples, the server engine(s) may be implemented as electronic circuitry.

In one example, the server engine(s) may include a server communication engine and other server engine(s). The other server engine(s) may further implement functionalities that supplement functions performed by the response generating application server or any of the server engine(s). The server communication engine may be a wireless communication module. Examples of the server communication engine may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the server communication engine may also include one or more antennas to enable wireless transmission and reception of data and signals.

The server data includes data that is either received, stored, or generated as a result of functions implemented by any of the server engine(s) or the response generating application server. It may be further noted that information stored and available in the server data may be utilized by the server engine(s) for performing various functions by the response generating application server. The server data may include generated responses, generated prompts, and other server data.

The communication environment in combination with the system environment 200 may be used to generate the responses to the queries. Although, for brevity, only a single system 100, has been illustrated for accessing the response generating application, it would be understood by a person skilled in the art that the response generating application may also be accessed separately through separate systems by same or different users.

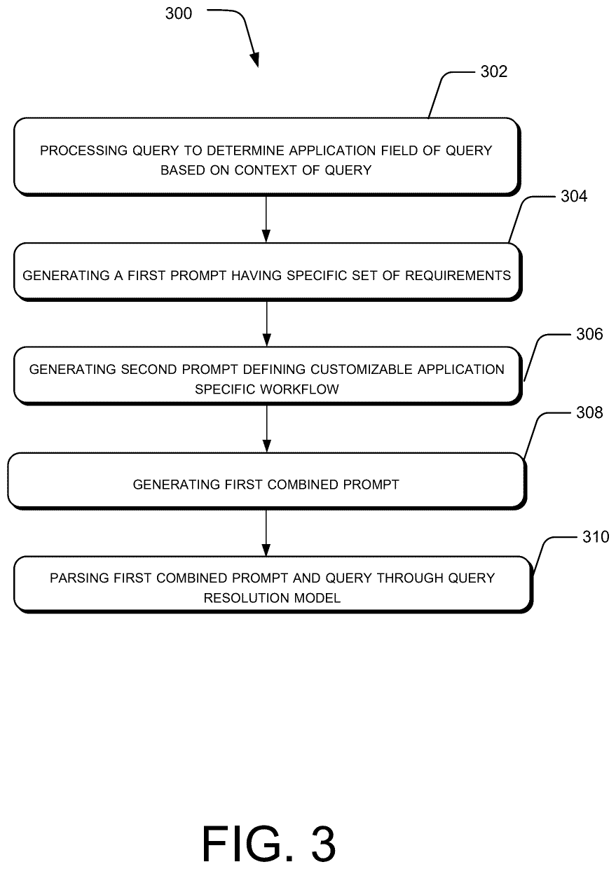

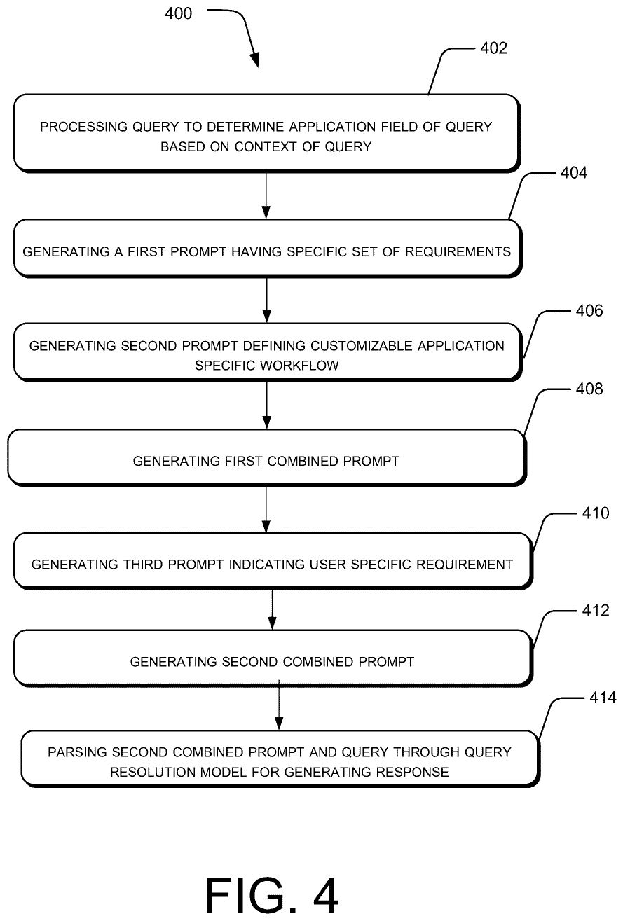

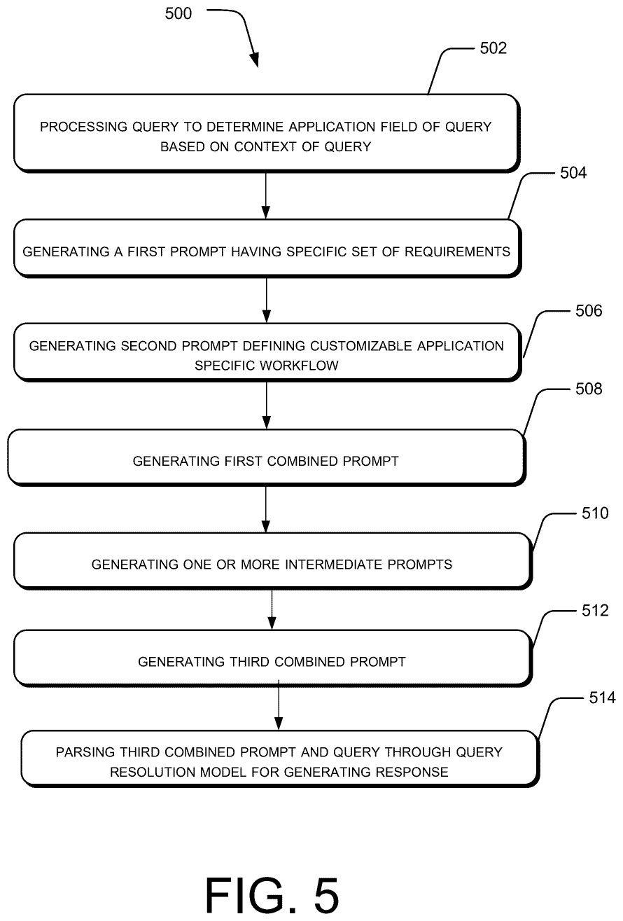

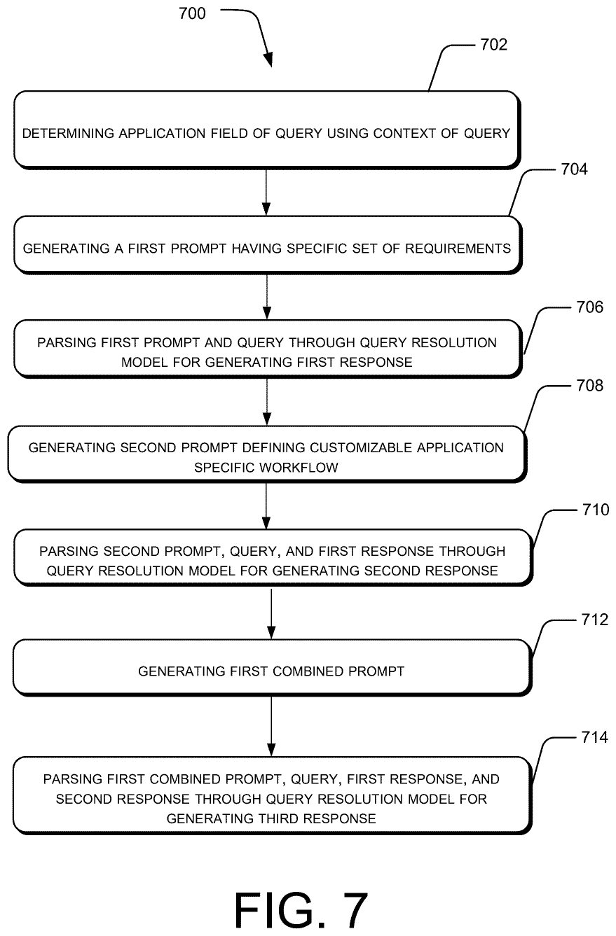

FIG. 3, FIG. 4, FIG. 5, and FIG. 7 illustrate example methods 300, 400, 500, and 700, respectively, for generating purpose driven responses to queries, according to different examples. The order in which the methods are described is not intended to be construed as a limitation, and any number of the described method blocks may be combined in any order to implement the methods, or an alternative method. Further, the methods 300, 400, 500, and 700 may be implemented by processing resource or computing device(s) through any suitable hardware, non-transitory machine-readable instructions, or combination thereof.

It may also be understood that methods 300, 400, 500, and 700 may be performed by programmed computing devices, such as the system 100, as depicted in FIG. 1 and FIG. 2. Furthermore, the methods 300, 400, 500, and 700 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 300, 400, 500, and 700 are described below with reference to the system 100 as described above, other suitable systems for the execution of these methods may also be utilized. Additionally, implementation of these methods is not limited to such examples.

Referring to FIG. 3, the method 300 may be implemented by a system for generating purpose driven responses to queries received from any user. The system may be similar to the system of FIGS. 1&2.

FIG. 3 illustrates a method 300 for generating purpose driven responses to queries received from a user, according to an example. The order in which the above-mentioned methods are described is not intended to be construed as a limitation, and some of the described method blocks may be combined in a different order to implement the method, or an alternative method.

At block 302, the method includes processing a query to determine an application field of the query based on a context of the query. When the system 100 receives the query, the context of the query may be analyzed to ascertain the application field of the query, because the query may be related to a specific application field and the context may be associated to said specific application field. For example, if the query is for a supply chain management for a manufacturing industry, the context of the query will be an indicative of supply chain management that may direct the query to relevant resources. The processing of the query is a stepping stone for generating a tailored response to the query.

At block 304, the method includes generating a first prompt having a specific set of requirements. In an example, any number of prompts may be generated depending on granularity requirement of the response anticipated by the user. The first prompt may include a set of fixed instructions for constraining the response to be received via a Large Language Model. The specific set of requirements of the first prompt may define a customizable format to be used for delivering a response to a user in reply to the query. In an example, a template for the response may be devised with the first prompt. For example, a specific length of the response, a specific purpose, specific regulatory requirements, disclaimers, or a general tone in which a response is to be delivered to a user. An example template may be “Please provide response in about 500 words but more than 350 words using concise and citation-specific manner. If you cannot answer relevantly, please suggest changes to be made to the query for finding the correct answer.’. The customizable template ensures uniformity in the responses to be delivered.

At block 306, the method includes generating a second prompt defining a customizable application specific workflow. The second prompt generation is advised after setting the template via the first prompt. In an example, the second prompt may define a customizable application specific workflow associated with the application field of the query. For example, for the application related to a product quality review, the application specific workflow may be customized to include submodules such as quality aspects, manufacturing process, and compliance aspects. Such application specific workflow may be customized as per the application requirements. The second prompt is customizable depending on the application specific workflow and may vary from one application to another. In an example, the second prompt may be a set of fixed instructions to constrain the response to be generated. The second prompt is from the perspective of the application and its various submodules, it is generated to be pertaining to the flows within the application. For example, the context at the second prompt may be for example from a Recall application perspective, then the workflows may be like Global partition signal detection->Quality Investigation->Process owner recall investigation->Recall Execution->Recall Disposition->Recall communication. The second prompt may be associated with one or more layers depending on the application type. Another example could be for Quality Investigation prompt “Please return the response with the statement that the Quality investigation done across all phases of the financial impact data, risk assessment data and quality material logistics suggest If you are not sure, please return the statement, kindly read the quality investigation done by process owners PO1, PO2, PO3 etc. to generate the Executive Quality Summary investigation”. The second prompt adds consistency in the way a response is generated for a customer along with the general tone and reference in addition to what is set by the first prompt.

At block 308, the method includes generating a first combined prompt. After setting the template of the response to be delivered and the customized application specific workflow at blocks 304, 306, the context of the first prompt and context of the second prompt are combined for generating the first combined prompt to move an inch closer to generation of the response to the query. This combination of the context of the first prompt and context of the second prompt is extremely important to ensure that the context of the first prompt and context of the second prompt are not sent separately but as a combined prompt for specifying a clearer purpose and to ensure that any customized aspect is not missed out.

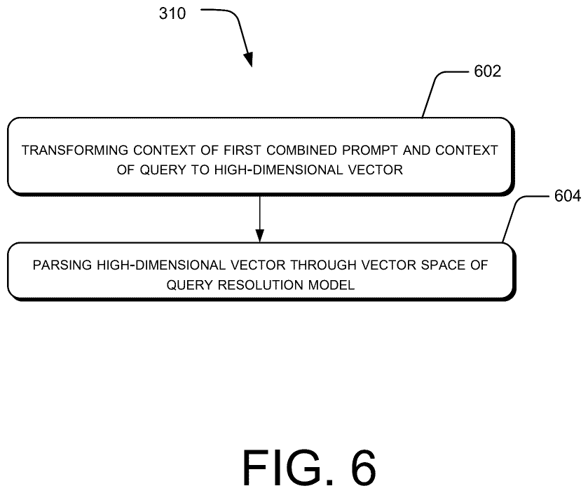

At block 310, when the required prompts are ready, the method includes parsing the first combined prompt and the query through a query resolution model for generating the response to the query. Parsing of the first combined prompt and the query through the query resolution model instead of only the query ensures that only relevant data associated with the first combined prompt and the query is captured for generating a precise response to the query, which would have not happened if only the query is parsed through the query resolution model. The first combined prompt helps the query resolution model in filtering out the unnecessary details. The parsing of the first combined prompt and the query through the query resolution model is explained in detail in FIG. 6. illustrating a flowchart of parsing of the first combined prompt and the query through the query resolution model, according to an example.

At block 602, the method includes transforming context of the first combined prompt and the context of the query to a high-dimensional vector. The high-dimensional vector may represent semantic and syntactic characteristics of the contexts that are recognizable in a vector space. The high-dimensional vector is workable when any open artificial intelligence based model, such as Large Language Model is used.

At block 604, the method includes parsing the high-dimensional vector through a vector space of the query resolution model. The parsing is done for searching vector embeddings in the vector space close to the high-dimensional vector. The vector space close to the high-dimensional vector is an indicative of location of the precise response to the query. In some cases, the high-dimensional vector is parsed through a vector space of the query resolution model to search for vector embeddings in the vector space that are close to the high-dimensional vector. This parsing process may involve various machine learning algorithms and techniques, such as nearest neighbor search, cosine similarity, or other distance metrics, to identify vector embeddings in the vector space that are semantically and syntactically similar to the high-dimensional vector.

In an example, the query resolution model is an open artificial intelligence based model. In an example, the query resolution model may be a Large Language Model. In an example, the query resolution model may not be restricted to a Large Language Model and any open artificial intelligence based model may be used.

FIG. 4 illustrates a flowchart of a method for generating purpose driven responses to queries received from a user, according to an example.

At block 402, the method includes processing a query to determine an application field of the query based on a context of the query similar to block 302 of FIG. 3. When the query is received, the context of the query may be analyzed to ascertain the application field of the query. The processing of the query is a preliminary step for generating a tailored response to the query.

At block 404, the method includes generating a first prompt having a specific set of requirements similar to block 304 of FIG. 3. The first prompt may include a set of fixed instructions for constraining the response to be received via a Large Language Model. The specific set of requirements of the first prompt may define a customizable format or template to be used for delivering a response to a user in reply to the query. For example, a specific length of the response, a specific purpose, specific regulatory requirements, disclaimers, or a general tone in which a response is to be delivered to a user.

At block 406, the method includes generating a second prompt defining a customizable application specific workflow similar to block 306 of FIG. 3. In an example, the second prompt may define a customizable application specific workflow associated with the application field of the query. The second prompt is customizable depending on the application specific workflow and may vary from one application to another. The second prompt is from the perspective of the application and its various submodules, it is generated to be pertaining to the flows within the application. The second prompt may be associated with one or more layers depending on the application type.

At block 408, the method includes generating a first combined prompt similar to block 308 of FIG. 3. In an example, the context of the first prompt and context of the second prompt are combined for generating the first combined prompt for generation of the response to the query. This combination of the context of the first prompt and context of the second prompt is extremely important to ensure that the context of the first prompt and context of the second prompt are not sent separately but as a combined prompt for specifying a clearer purpose and to ensure that any customized aspect is not missed out.

At block 410, the method includes generating a third prompt indicating a user specific requirement. The user specific requirement may include an additional context specifying the user specific requirement. The user specific requirement defines a specific user role, where the privilege of the user is considered to generate a meaningful prompt. For example, a user “Nick” may provide a dialogue box indicating the precise purpose of the query clarifying the intention that could be extremely specific to the purpose of the task.

At block 412, the method includes generating a second combined prompt. Such a generation may be done by combining context of the first combined prompt and context of the third prompt and at block 414, when the required prompts are ready, the method includes parsing the second combined prompt and the query through the query resolution model for generating the response to the received query. Also, the combining of the contexts of the first combined prompt and the third prompt ensures that the context of the first combined prompt and the context of the third prompt are not sent separately but as a combined prompt for specifying a clearer purpose and to ensure that any customized aspect is not missed out. During the parsing, only relevant data associated with the second combined prompt and the query may be obtained for generating a precise response to the query. For example, for parsing the second combined prompt and the query through the query resolution model, context of the second combined prompt and the context of the query are transformed to a high-dimensional vector representing semantic and syntactic characteristics of the contexts and said the high-dimensional vector may be parsed through a vector space of the query resolution model for searching vector embeddings in the vector space close to the high-dimensional vector for locating the precise response to the query.

FIG. 5 illustrates a flowchart of a method for generating purpose driven responses to queries received from a user, according to an example.

At block 502, the method includes processing a query to determine an application field of the query based on a context of the query similar to block 302 of FIG. 3. When the query is received, the context of the query may be analyzed to ascertain the application field of the query. The processing of the query is a preliminary step for generating a tailored response to the query.

At block 504, the method includes generating a first prompt having a specific set of requirements similar to block 304 of FIG. 3. The first prompt may include a set of fixed instructions for constraining the response to be received via a Large Language Model. The specific set of requirements of the first prompt may define a customizable format or template to be used for delivering a response to a user in reply to the query. For example, a specific length of the response, a specific purpose, specific regulatory requirements, disclaimers, or a general tone in which a response is to be delivered to a user.

At block 506, the method includes generating a second prompt defining a customizable application specific workflow similar to block 306 of FIG. 3. In an example, the second prompt may define a customizable application specific workflow associated with the application field of the query. The second prompt is customizable depending on the application specific workflow and may vary from one application to another. The second prompt is from the perspective of the application and its various submodules, it is generated to be pertaining to the flows within the application. The second prompt may be associated with one or more layers depending on the application type.

At block 508, the method includes generating a first combined prompt similar to block 308 of FIG. 3. In an example, the context of the first prompt and context of the second prompt are combined for generating the first combined prompt for generation of the response to the query. This combination of the context of the first prompt and context of the second prompt is extremely important to ensure that the context of the first prompt and context of the second prompt are not sent separately but as a combined prompt for specifying a clearer purpose and to ensure that any customized aspect is not missed out.

At block 510, the method includes generating one or more intermediate prompts. The one or more intermediate prompts are to specify additional context for the application specific workflow. In an example, the additional context may relate to a context not specified in sub-modules of the application specific workflow. The one or more intermediate prompts are to ensure that there is no limitation on the number of layers or prompts and users may choose more layers of nesting and construction of prompts before sending to the query resolution model to get a more tailored response. In an example, each of the first prompt, the second prompt, the third prompt, and the one or more intermediate prompts corresponds to a layer of the query resolution model.

At block 512, the method includes generating a third combined prompt by combining context of the first combined prompt and context of the one or more intermediate prompts. In an example, if the one or more intermediate prompts are generated after the third prompt, a third combined prompt may be generated by combining context of the second combined prompt and context of the one or more intermediate prompts.

At block 514, when the required prompts are ready, the method includes parsing the third combined prompt and the query through the query resolution model for generating the response to the received query. During the parsing, only relevant data associated with the third combined prompt and the query may be obtained for generating a precise response to the query. For example, for parsing the third combined prompt and the query through the query resolution model, context of the third combined prompt and the context of the query are transformed to a high-dimensional vector representing semantic and syntactic characteristics of the contexts and said the high-dimensional vector may be parsed through a vector space of the query resolution model for searching vector embeddings in the vector space close to the high-dimensional vector for locating the precise response to the query.

FIG. 7 illustrates a method 700 for generating purpose driven responses to queries received from a user, according to an example.

At block 702, the method includes determining an application field of a query using a context of the query received from a user. The context of the query may be analyzed to ascertain the application field of the query, because the query may be related to a specific application field and the context may be associated to said specific application field. For example, if the query is for a supply chain management for a manufacturing industry, the context of the query will be an indicative of supply chain management that may direct the query to relevant resources. The processing of the query is a stepping stone for generating a tailored response to the query.

At block 704, the method includes generating a first prompt having a specific set of requirements. In an example, any number of prompts may be generated depending on granularity requirement of the response anticipated by the user. The first prompt may include a set of fixed instructions for constraining the response to be received via a Large Language Model. The specific set of requirements of the first prompt may define a customizable format to be used for delivering a response to a user in reply to the query. In an example, a template for the response may be devised with the first prompt. For example, a specific length of the response, a specific purpose, specific regulatory requirements, disclaimers, or a general tone in which a response is to be delivered to a user. An example template may be “Please provide response in about 500 words but more than 350 words using concise and citation-specific manner. If you cannot answer relevantly, please suggest changes to be made to the query for finding the correct answer.’. The customizable template ensures uniformity in the responses to be delivered.

At block 706, the method includes parsing the first prompt and the query through a query resolution model for generating a first response to the query. This parsing is done to obtain a very large generic response, i.e., the first response which may be used subsequently for a refined response generation.

At block 708, the method includes generating a second prompt defining a customizable application specific workflow. The second prompt may be a set of fixed instructions to constrain the response to be generated. In an example, the second prompt may define a customizable application specific workflow associated with the application field of the query. For example, for the application related to a product quality review, the application specific workflow may be customized to include submodules such as quality aspects, manufacturing process, and compliance aspects. Such application specific workflow may be customized as per the application requirements. The second prompt is customizable depending on the application specific workflow and may vary from one application to another. The second prompt is from the perspective of the application and its various submodules, it is generated to be pertaining to the flows within the application. For example, the context at the second prompt may be for example from a Recall application perspective, then the workflows may be like Global partition signal detection->Quality Investigation->Process owner recall investigation->Recall Execution->Recall Disposition->Recall communication. The second prompt may be associated with one or more layers depending on the application type. Another example could be for Quality Investigation prompt “Please return the response with the statement that the Quality investigation done across all phases of the financial impact data, risk assessment data and quality material logistics suggest . . . . If you are not sure, please return the statement, kindly read the quality investigation done by process owners PO1, PO2, PO3 etc. to generate the Executive Quality Summary investigation”. The second prompt adds consistency in the way a response is generated for a customer along with the general tone and reference in addition to what is set by the first prompt.

At block 710, the method includes parsing the second prompt, the query, and the first response through the query resolution model for generating a second response to the query. The second response may be a large generic response that may be used subsequently for a refined response generation. In an example, the second response may be less generic than the first response.

At block 712, the method includes generating a first combined prompt by combining context of the first prompt and context of the second prompt and at block 714, the method parsing the first combined prompt, the query, the first response, and the second response through the query resolution model for generating a third response to the query. In an example, the third response may be a final response. In an example, if more prompts are to be generated, the third response may be a generic response that may be used subsequently for a refined response generation. In an example, the third response may be less generic than the second response. In each case, the combined prompt ensures that the contexts of the prompts forming the combined prompt are not sent separately but as a combined prompt for specifying a clearer purpose and to ensure that any customized aspect is not missed out. After every parsing step, only relevant data associated with one or more of the prompts, the query, and the response is obtained for generating a precise response to the query. In an example, for the parsing, the context of the prompts, the context of the query, and the context of the generated responses are transformed to a high-dimensional vector representing semantic and syntactic characteristics of the contexts. Further, the high-dimensional vector may be then parsed through a vector space of the query resolution model for searching vector embeddings in the vector space close to the high-dimensional vector. The vector space close to the high-dimensional vector is an indicative of location of the precise response to the query. In an example, the generated response, such as first response, second response, third response, or any other subsequently generated response may be evaluated by measuring one or more of coherence, relevance to context of the query, grammatical correctness, and factual accuracy against a prespecified standard. In addition, user feedback may be received on the final response. The user feedback may be based one or more of coherence, relevance to context of the query, grammatical correctness, and factual accuracy against a prespecified standard. This evaluation may involve various natural language processing techniques and metrics, such as BLEU score, ROUGE score, or other evaluation metrics, to assess the quality and relevance of the generated response.

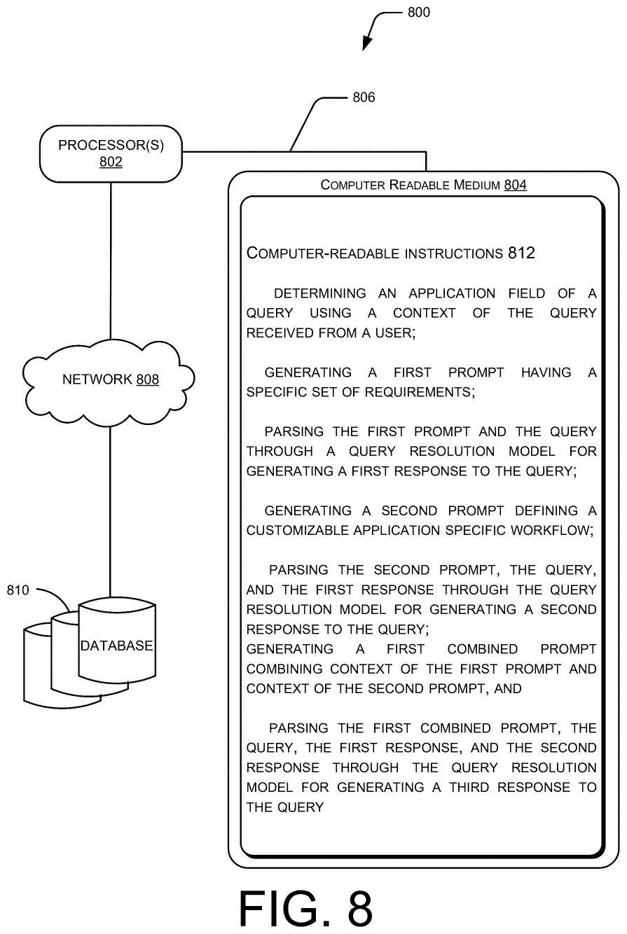

FIG. 8 illustrates a system environment 800 implementing a non-transitory computer readable medium for generating purpose driven responses to queries received from users, according to an example. In an example, the system environment 800 includes processor(s) 802 communicatively coupled to a non-transitory computer readable medium 804 through a communication link 806. In an example, the processor(s) 802 may have one or more processing resources for fetching and executing computer-readable instructions from the non-transitory computer readable medium 804. The processor(s) 802 and the non-transitory computer readable medium 804 may be implemented, for example, in the system 100 (as has been described in conjunction with the preceding figures).

The non-transitory computer readable medium 804 may be, for example, an internal memory device or an external memory device. In an example implementation, the communication link 806 may be a network communication link. The processor(s) 802 may access the non-transitory computer readable medium 804 through a network 808. The network 808 may be a single network or a combination of multiple networks and may use a variety of communication protocols. The processor(s) 802 and the non-transitory computer readable medium 804 may also be communicatively coupled to a data source 810 over the network 808. The data source 810 may include, for example, a database.

In an example implementation, the non-transitory computer readable medium 804 includes a set of computer readable instructions (hereinafter may also be referred as instructions) 812 which may be accessed by the processor(s) 802 through the communication link 806. Referring to FIG. 8, in an example, the non-transitory computer readable medium 804 includes instructions 812 that may cause the processor(s) 802 to determine an application field of a query using a context of the query received from a user. The context of the query may be analyzed to ascertain the application field of the query, because the query may be related to a specific application field and the context may be associated to said specific application field. For example, if the query is for a supply chain management for a manufacturing industry, the context of the query will be an indicative of supply chain management that may direct the query to relevant resources. The processing of the query is a stepping stone for generating a tailored response to the query.

Further, the instructions 812 may cause the processor(s) 802, to generate a first prompt having a specific set of requirements. In an example, any number of prompts may be generated depending on granularity requirement of the response anticipated by the user. The first prompt may include a set of fixed instructions for constraining the response to be received via a Large Language Model. The specific set of requirements of the first prompt may define a customizable format to be used for delivering a response to a user in reply to the query. In an example, a template for the response may be devised with the first prompt. For example, a specific length of the response, a specific purpose, specific regulatory requirements, disclaimers, or a general tone in which a response is to be delivered to a user. An example template may be “Please provide response in about 700 words but more than 650 words using concise and citation-specific manner. If you cannot answer relevantly, please suggest changes to be made to the query for finding the correct answer.’. The customizable template ensures uniformity in the responses to be delivered.

Further, the instructions 812 may cause the processor(s) 802, to parse the first prompt and the query through a query resolution model for generating a first response to the query. This parsing is done to obtain a very large generic response, i.e., the first response which may be used subsequently for a refined response generation.

Further, the instructions 812 may cause the processor(s) 802, to generate a second prompt defining a customizable application specific workflow. The second prompt may be a set of fixed instructions to constrain the response to be generated. In an example, the second prompt may define a customizable application specific workflow associated with the application field of the query. For example, for the application related to a product quality review, the application specific workflow may be customized to include submodules such as quality aspects, manufacturing process, and compliance aspects. Such application specific workflow may be customized as per the application requirements. The second prompt is customizable depending on the application specific workflow and may vary from one application to another. The second prompt is from the perspective of the application and its various submodules, it is generated to be pertaining to the flows within the application. For example, the context at the second prompt may be for example from a Recall application perspective, then the workflows may be like Global partition signal detection->Quality Investigation->Process owner recall investigation->Recall Execution->Recall Disposition->Recall communication. The second prompt may be associated with one or more layers depending on the application type. The second prompt adds consistency in the way a response is generated for a customer along with the general tone and reference in addition to what is set by the first prompt.

Further, the instructions 812 may cause the processor(s) 802, to parse the second prompt, the query, and the first response through the query resolution model for generating a second response to the query. The second response may be a large generic response that may be used subsequently for a refined response generation. In an example, the second response may be less generic than the first response.

Further, the instructions 812 may cause the processor(s) 802, to generate a first combined prompt by combining context of the first prompt and context of the second prompt and the instructions 812 may cause the processor(s) 802, to parse the first combined prompt, the query, the first response, and the second response through the query resolution model for generating a third response to the query. In an example, the third response may be a final response. In an example, if more prompts are to be generated, the third response may be a generic response that may be used subsequently for a refined response generation. In an example, the third response may be less generic than the second response. In each case, the combined prompt ensures that the contexts of the prompts forming the combined prompt are not sent separately but as a combined prompt for specifying a clearer purpose and to ensure that any customized aspect is not missed out. After every parsing step, only relevant data associated with one or more of the prompts, the query, and the response is obtained for generating a precise response to the query.

Further, the instructions 812 may cause the processor(s) 802, to generate a third prompt indicating a user specific requirement. The user specific requirement may include an additional context specifying the user specific requirement. The user specific requirement defines a specific user role, where the privilege of the user is considered to generate a meaningful prompt. For example, a user “Nick” may provide a dialogue box indicating the precise purpose of the query clarifying the intention that could be extremely specific to the purpose of the task.

The instructions 812 may cause the processor(s) 802, to parse the third prompt, the query, the first response, the second response, and the third response through the query resolution model for generating a fourth response to the query. The fourth response may be a generic response that may be used subsequently for a refined response generation. In an example, the fourth response may be less generic than the third response.

Further, the instructions 812 may cause the processor(s) 802, to generate a second combined prompt. Such a generation may be done by combining context of the first combined prompt and context of the third prompt. When the required prompts are ready, the instructions 812 may cause the processor(s) 802, to parse the second combined prompt, the query, the first response, the second response, the third response, and the fourth response through the query resolution model for generating a final response to the received query. During the parsing, only relevant data associated with the second combined prompt and the query may be obtained for generating a precise response to the query.

In another example, the instructions 812 may cause the processor(s) 802, to generate one or more intermediate prompts. The one or more intermediate prompts are to specify additional context for the application specific workflow. In an example, the additional context may relate to a context not specified in sub-modules of the application specific workflow. The one or more intermediate prompts are to ensure that there is no limitation on the number of layers or prompts and users may choose more layers of nesting and construction of prompts before sending to the query resolution model to get a more tailored response. In an example, each of the first prompt, the second prompt, the third prompt, and the one or more intermediate prompts corresponds to a layer of the query resolution model.

Further, the instructions 812 may cause the processor(s) 802, to generate a third combined prompt by combining context of the first combined prompt and context of the one or more intermediate prompts. In an example, if the one or more intermediate prompts are generated after the third prompt, a third combined prompt may be generated by combining context of the second combined prompt and context of the one or more intermediate prompts.

Further, when the required prompts are ready, the instructions 812 may cause the processor(s) 802, to parse the third combined prompt and the query through the query resolution model for generating a final response to the received query. During the parsing, only relevant data associated with the third combined prompt and the query may be obtained for generating a precise response to the query. For example, for parsing the third combined prompt and the query through the query resolution model, context of the third combined prompt and the context of the query are transformed to a high-dimensional vector representing semantic and syntactic characteristics of the contexts and said the high-dimensional vector may be parsed through a vector space of the query resolution model for searching vector embeddings in the vector space close to the high-dimensional vector for locating the precise response to the query.

Also, the instructions 812 may cause the processor(s) 802, to evaluate the generated response by measuring one or more of coherence, relevance to context of the query, grammatical correctness, and factual accuracy against a prespecified standard.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
processing a query to determine an application field of the query based on a context of the query;
generating a first prompt having a specific set of requirements, wherein the specific set of requirements defines a customizable format to be used for delivering a response to a user in reply to the query;
generating a second prompt defining a customizable application specific workflow, wherein the customizable application specific workflow is associated with the application field of the query;
generating a first combined prompt by combining context of the first prompt and context of the second prompt; and
parsing the first combined prompt and the query through a query resolution model for generating the response to the query.

2. The method as claimed in claim 1, further comprising:
generating a third prompt indicating a user specific requirement having an additional context specifying the user specific requirement;
generating a second combined prompt by combining context of the first combined prompt and the context of the third prompt; and
parsing the second combined prompt and the query through the query resolution model for generating the response to the query.

3. The method as claimed in claim 1, further comprising:
generating one or more intermediate prompts after the generation of the second prompt, wherein the one or more intermediate prompts are to specify additional context for the customizable application specific workflow, wherein the additional context is not specified in sub-modules of the customizable application specific workflow; and
generating a third combined prompt by combining context of the first combined prompt and the context of the one or more intermediate prompts; and
parsing the third combined prompt and the query through the query resolution model for generating the response to the query.

4. The method as claimed in claim 1, wherein the specific set of requirements comprises one or more of a specific length of the response, a specific purpose, specific regulatory requirements, disclaimers, and a general tone in which a response is to be delivered to the user.

5. The method as claimed in claim 1, wherein the query resolution model is an open artificial intelligence based model.

6. The method as claimed in claim 2, wherein each of the first prompt, the second prompt, and the third prompt corresponds to a layer of the query resolution model.

7. The method as claimed in claim 1, wherein the response is one of an answer to the query, a newly generated text, a summarized text, and an analysis report.

8. The method as claimed in claim 1, further comprising evaluating the generated response by measuring one or more of coherence, relevance to context of the query, grammatical correctness, and factual accuracy against a prespecified standard.

9. The method as claimed in claim 1, wherein parsing the first combined prompt and the query through the query resolution model comprises:
transforming context of the first combined prompt and the context of the query to a high-dimensional vector representing semantic and syntactic characteristics of the contexts; and
parsing the high-dimensional vector through a vector space of the query resolution model for searching vector embeddings in the vector space close to the high-dimensional vector.

10. A system comprising:
a query resolution engine to:
determine an application field of a query using a context of the query received from a user;
generate a first prompt having a specific set of requirements, wherein the specific set of requirements defines a customizable format to be used for delivering a response to the user in reply to the query;
parse the first prompt and the query through a query resolution model for generating a first response to the query;
generate a second prompt defining a customizable application specific workflow, wherein the customizable application specific workflow is associated with the application field of the query;
parse the second prompt, the query, and the first response through the query resolution model for generating a second response to the query;
generate a first combined prompt combining context of the first prompt and context of the second prompt; and
parse the first combined prompt, the query, the first response, and the second response through the query resolution model for generating a third response to the query.

11. The system as claimed in claim 10, wherein the query resolution engine is to:
generate a third prompt indicating a user specific requirement having an additional context specifying the user specific requirement;
generate a second combined prompt combining context of the first combined prompt and the context of the third prompt; and
parsing the second combined prompt, the query, the first response, the second response, and the third response through the query resolution model for generating a final response to the query.

12. The system as claimed in claim 10, wherein the query resolution engine is to:
generate one or more intermediate prompts after the generation of the second prompt, wherein the one or more intermediate prompts are to specify additional context for the customizable application specific workflow, wherein the additional context is not specified in sub-modules of the customizable application specific workflow;
generate a third combined prompt combining context of the first combined prompt and the context of the one or more intermediate prompts; and
parsing the third combined prompt, the query, the first response, the second response, and the third response through the query resolution model for generating a final response to the query.

13. The system as claimed in claim 10, wherein the query resolution model is a Large Language Model.

14. The system as claimed in claim 11, wherein the query resolution engine is to:
transform contexts of the first prompt, the second prompt, the third prompt, the first combined prompt, the second combined prompt, the query, the first response, the second response, and the third response to a high-dimensional vector representing semantic and syntactic characteristics of the contexts; and
parse the high-dimensional vector through a vector space of the query resolution model for searching vector embeddings in the vector space close to the high-dimensional vector.

15. The system as claimed in claim 10, further comprising a feedback engine to receive a user feedback on the third response, wherein the user feedback is based one or more of coherence, relevance to context of the query, grammatical correctness, and factual accuracy against a prespecified standard.

16. The system as claimed in claim 10, further comprising an evaluation engine to evaluate the generated responses by measuring one or more of coherence, relevance to context of the query, grammatical correctness, and factual accuracy against a prespecified standard.

17. A non-transitory computer readable medium having instructions stored thereon, the instructions, when executed by a processor, cause the processor to perform operations comprising:
determining an application field of a query using a context of the query received from a user;
generating a first prompt having a specific set of requirements, wherein the specific set of requirements defines a customizable format to be used for delivering a response to the user in reply to the query;
parsing the first prompt and the query through a query resolution model for generating a first response to the query;
generating a second prompt defining a customizable application specific workflow, wherein the customizable application specific workflow is associated with the application field of the query;
parsing the second prompt, the query, and the first response through the query resolution model for generating a second response to the query;
generating a first combined prompt combining context of the first prompt and context of the second prompt; and
parsing the first combined prompt, the query, the first response, and the second response through the query resolution model for generating a third response to the query.

18. The non-transitory computer readable medium as claimed in claim 17, further comprising:
generating a third prompt indicating a user specific requirement having an additional context specifying the user specific requirement;
parsing the third prompt, the query, the first response, the second response, and the third response through the query resolution model for generating a fourth response to the query
generate a second combined prompt combining context of the first combined prompt and context of the third prompt; and
parsing the second combined prompt, the query, the first response, the second response, the third response, and the fourth response through the query resolution model for generating a final response to the query.

19. The non-transitory computer readable medium as claimed in claim 17, further comprising:
generating one or more intermediate prompts after the generation of the second prompt, wherein the one or more intermediate prompts are to specify additional context of the customizable application specific workflow, wherein the additional context is not specified in sub-modules of the customizable application specific workflow; and
generating a third combined prompt by combining context of the first combined prompt and context of the one or more intermediate prompts; and
parsing the third combined prompt and the query through the query resolution model for generating a final response to the query.

20. The non-transitory computer readable medium as claimed in claim 17, further comprising evaluating the generated response by measuring one or more of coherence, relevance to context of the query, grammatical correctness, and factual accuracy against a prespecified standard.
